(19) United States
(12) Patent Application Publication
(10) Pub. No.: US 2011/0074763 A1
(43) Pub. Date: Mar. 31, 2011

(54) LIQUID CRYSTAL DISPLAY POWER SUPPLYING CIRCUIT

(75) Inventors: He-Kang ZHOU, Shenzhen (CN); Ching-Chung LIN, Miao-Li County (TW); Em-Ily YANG, Shenzhen (CN); Jin-Ming LIU, Shenzhen (CN)

(73) Assignees: INNOCOM TECHNOLOGY (SHENZHEN) CO., LTD., Shenzhen City (CN); Chimei Innolux Corporation, Miao-Li County (TW)

(21) Appl. No.: 12/878,955

(22) Filed: Sep. 9, 2010

(30) Foreign Application Priority Data
Sep. 28, 2009 (CN) 200910307860.9

(51) Int. Cl. G09G 5/00

(52) U.S. Cl. 345/212

(57) ABSTRACT

A liquid crystal display (LCD) power supplying circuit includes a motherboard switch circuit, an LCD power circuit, a power switch circuit, and a first power supplying unit. An input terminal of the motherboard switch circuit is coupled to a power output terminal of a motherboard. An input terminal of the power switch circuit is coupled to the LCD power circuit. The first power supplying unit is coupled to an output terminal of the motherboard switch circuit, an output terminal of the power switch circuit and a microprocessor, and the first power supplying unit supplies power from the motherboard or power from the LCD power circuit to the microprocessor.

### CROSS REFERENCE TO RELATED APPLICATIONS

This application claims priority of Chinese Patent Application No. 200910307860.9 filed on Sep. 28, 2009, the entirety of which is incorporated by reference herein.

### BACKGROUND

1. Technical Field

The disclosure relates to a display power supplying circuit, and more particularly to a display power supplying circuit which is able to reduce power consumption.

2. Description of Related Art

In general, a liquid crystal display (LCD) may enter a sleep display mode to reduce power consumption, and a single LCD power source is used to supply the LCD wither a sleep display mode or a normal display mode. In an LCD, the devices that need to be supplied power comprise a display panel, a microprocessor and an operational integrated circuit (IC), wherein a voltage level of the LCD power is about 5 volts, a power that the display panel needs is about 5 volts, a power that the microprocessor needs is about 3.3 volts, and a power that the operational IC needs is about 1.8 volts.

Referring to FIG. 1, FIG. 1 shows a schematic illustrating a typical LCD power supplying circuit 100. As shown in FIG. 1, the LCD power supplying circuit 100 includes an LCD power circuit 110, a first power supplying unit 150, a second power supplying unit 160, a first filtering module 170, a second filtering module 180 and a diode D120. The LCD power supplying circuit 100 outputs a power VO1 (about 5 volts) generated by the LCD power circuit 110 to supply power for a display panel 120, a power VO2 (about 3.3 volts) generated by the first power supplying unit 150 to supply power for a microprocessor 130, and a power VO3 (about 1.8 volts) generated by the second power supplying unit 160 to supply power for an operational IC 140. When the display enters a sleep display mode, the microprocessor 130 sends a signal to the display panel 120 and the operational IC 140 to disable the display panel 120 and the operational IC 140, and then disables the normal functions to stop receiving the power VO1, VO2 and VO3 for the display. On the contrary, when the display enters a normal display mode from a sleep display mode, the microprocessor 130 sends a signal to the display panel 120 and the operational IC 140 to enable the display panel 120 and the operational IC 140, so as to continue receiving the power VO1, VO2 and VO3, respectively. However, a small current flows through the diode D120 when the display enters a sleep display mode, such that the LCD power circuit 110 operates at a lower efficiency state; thus generating power consumption that can not be ignored.

### SUMMARY OF THE INVENTION

A liquid crystal display (LCD) power supplying circuit is provided. The LCD power supplying circuit includes a motherboard switch circuit, an LCD power circuit, a power switch circuit, and a first power supplying unit. An input terminal of the motherboard switch circuit is coupled to a power output terminal of a motherboard. An input terminal of the power switch circuit is coupled to the LCD power circuit. The first power supplying unit is coupled to an output terminal of the motherboard switch circuit, an output terminal of the power switch circuit and a microprocessor, and the first power supplying unit supplies power from the motherboard or power from the LCD power circuit to the microprocessor.

A detailed description is given in the following embodiments with reference to the accompanying drawings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 shows a schematic illustrating a typical LCD power supplying circuit.

FIG. 2 and FIG. 3 show an LCD power supplying circuit according to a first embodiment and a second embodiment of the disclosure, respectively, wherein the LCD power supplying circuit is coupled to a motherboard and is used to provide three difference voltage power levels for the microprocessor, display panel and operational IC of FIG. 1.

FIG. 4 and FIG. 5 show a schematic illustrating the LCD power supplying circuit of FIG. 2 according to a third embodiment and a fourth embodiment of the disclosure, respectively.

FIG. 6 and FIG. 7 show a schematic illustrating an LCD power supplying circuit according to a fifth embodiment of the disclosure, wherein the LCD power supplying circuit of FIG. 6 and an LCD power circuit of FIG. 7 both need a control signal to trigger a mechanism for switching power.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

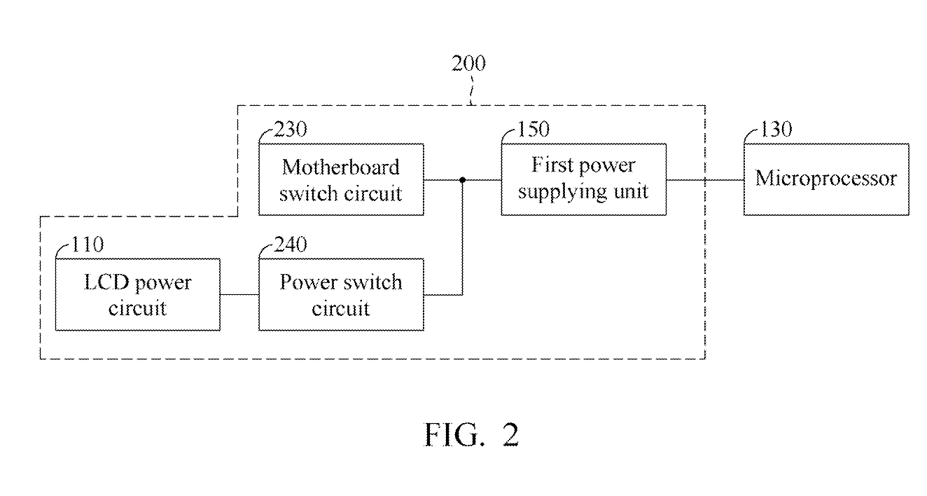

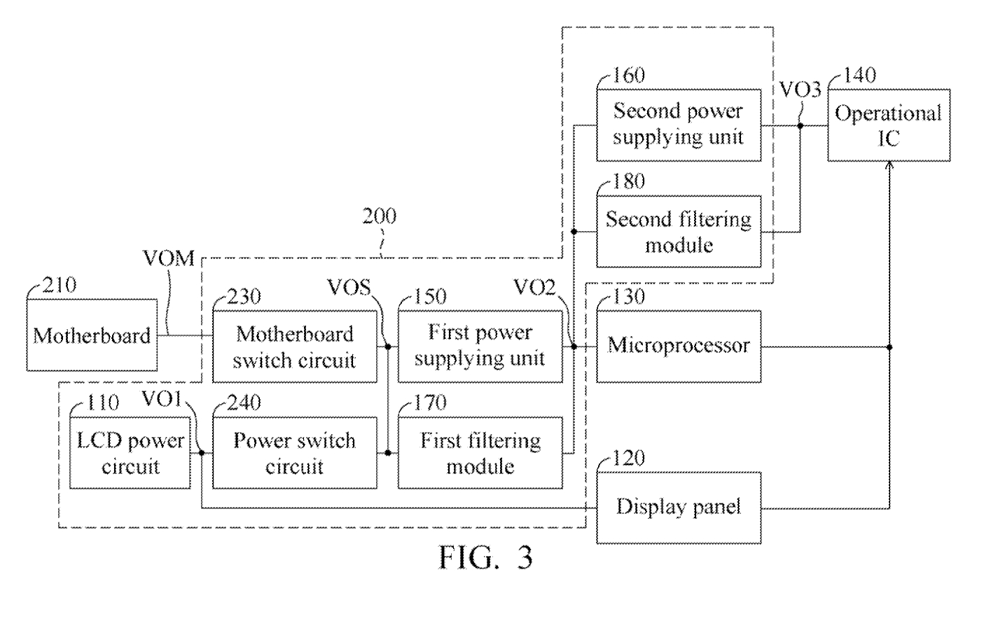

Referring to FIG. 2 and FIG. 3, FIG. 2 and FIG. 3 show a liquid crystal display power (LCD) power supplying circuit 200 according to a first embodiment and a second embodiment of the disclosure, respectively. FIG. 2 shows a schematic illustrating the LCD power supplying circuit 200 disclosed in the first embodiment, and FIG. 3 shows a schematic illustrating the LCD power supplying circuit 200 disclosed in the second embodiment.

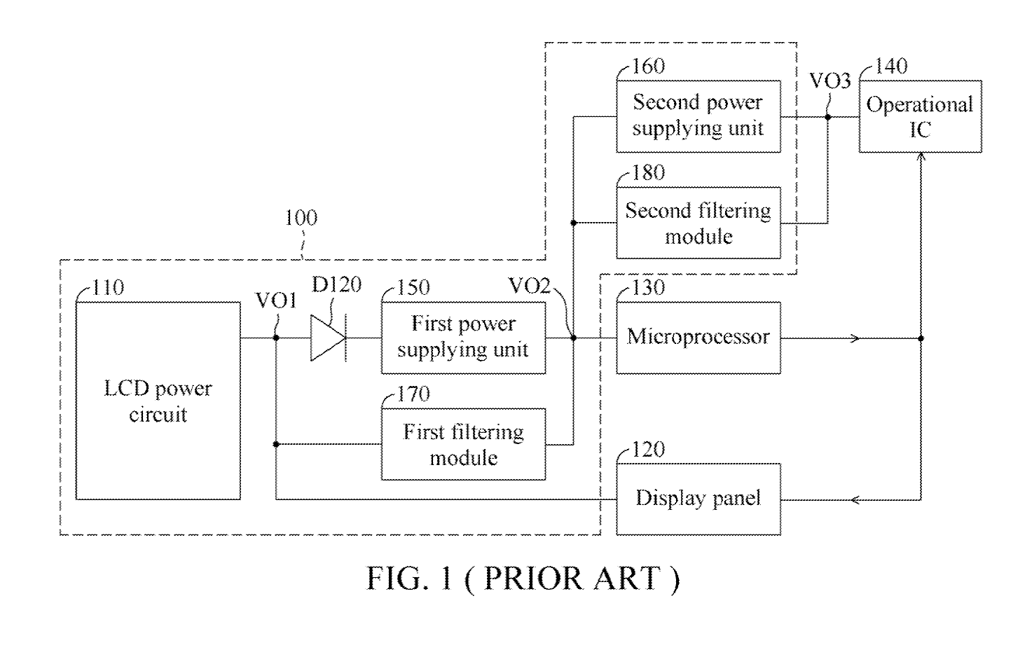

As shown in FIG. 2, in the first embodiment, the LCD power supplying circuit 200 comprises a motherboard switch circuit 230, a power switch circuit 240 and the LCD power circuit 110 and the first power supplying unit 150 both shown in FIG. 1. The first power supplying unit 150 is used to provide power from a motherboard or power from the LCD power circuit 110 to the microprocessor 130 via the motherboard switch circuit 230 or the power switch circuit 240. When a display enters a normal display mode, the LCD power supplying circuit 200 turns off the motherboard switch circuit 230 and turns on the power switch circuit 240, such that power from the motherboard may not be provided to the first power supplying unit 150 via the motherboard switch circuit 230 and power from the LCD power circuit 110 may be provided to the microprocessor 130 via the power switch circuit 240. On the contrary, when the display enters a sleep display mode, the LCD power supplying circuit 200 turns on the motherboard switch circuit 230 and turns off the power switch circuit 240, such that power from the motherboard may be provided to the first power supplying unit 150 via the motherboard switch circuit 230 and power from the LCD power circuit 110 may not be provided to the first power supplying unit 150 via the power switch circuit 240.

As shown in FIG. 3, in the second embodiment, the LCD power supplying circuit 200 is coupled to a motherboard 210 to provide three power sources with different voltage levels for the microprocessor 130, the display panel 120 and the operational integrated circuit (IC) 140 described in FIG. 1. As shown in FIG. 3, the LCD power supplying circuit 200 comprises the motherboard switch circuit 230, the power switch circuit 240 and the LCD power circuit 110, the first power supplying unit 150, the second power supplying unit 160, the first filtering module 170 and the second filtering module 180 described in FIG. 1.

Under a normal display mode, the LCD power supplying circuit 200 obtains a power VO1 from the LCD power circuit 110 for supplying the power VO1 to the display panel 120, and then turns on the power switch circuit 240, such that the power VO1 is input to the first power supplying unit 150. At this time, a power VOS at the input terminal of the first power supplying unit 150 is generated according to the power VO1, and the LCD power supplying circuit 200 turns off the motherboard switch circuit 230, so as to isolate the motherboard output power VOM generated by the motherboard 210. Thus, the first power supplying unit 150 converts the power VOS from the power switch circuit 240 into a power VO2 and provides the power VO2 to the microprocessor 130, and the second power supplying unit 160 generates a power VO3 according to the power VO2 and provides the power VO3 to the operational IC 140.

Under a sleep display mode, the microprocessor 130 generates a control signal to disable the operational IC 140 and the display panel 120, such that the display panel 120 does not consume the power VO1 provided by the LCD power circuit 110. Furthermore, the LCD power supplying circuit 200 may turn off the power switch circuit 240 and turn on the motherboard switch circuit 230, such that the power VOS received by the first power supplying unit 150 is generated according to the motherboard output power VOM generated by the motherboard 210 rather than the power VO1 provided by the LCD power circuit 110. At this time, the LCD power circuit 110 is operating in a state that no power is consumed due to the complete blockage of the power consumption paths; thus saving power under a sleep display mode for the LCD power circuit 110.

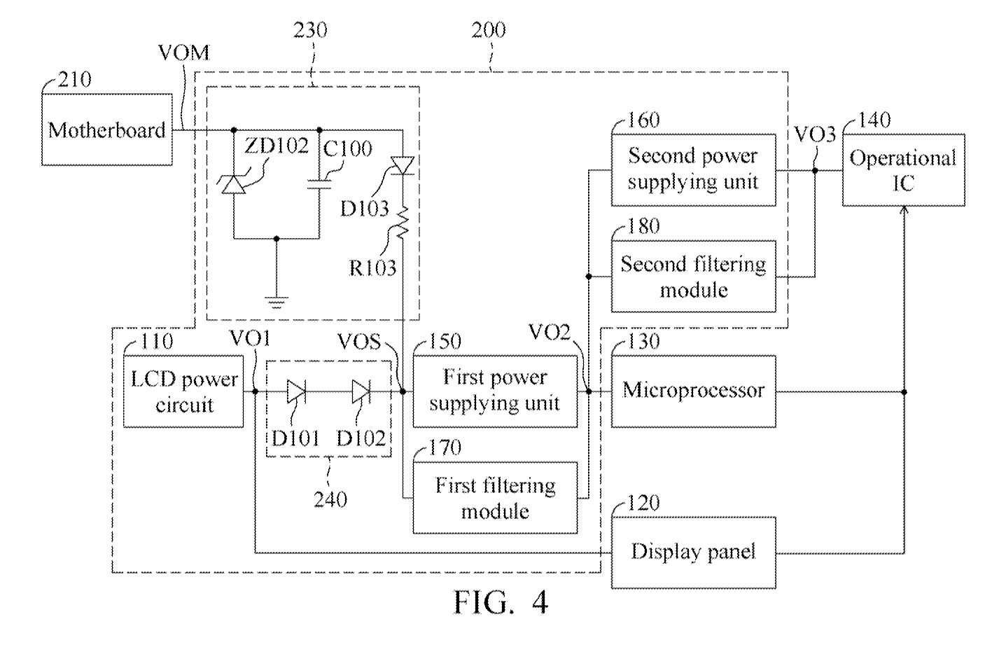

Referring to FIG. 4, FIG. 4 shows a schematic illustrating the LCD power supplying circuit 200 of FIG. 2 according to a third embodiment of the disclosure. FIG. 4 mainly shows the power switch circuit 240 and the motherboard switch circuit 230 of FIG. 2. As shown in FIG. 4, the motherboard switch circuit 230 includes a first diode D103, a resistor R103, a Zenar diode ZD102 and a capacitor C100. A first terminal of the first diode D103 is coupled to a power output terminal of the motherboard 210 for receiving the motherboard output power VOM. A first terminal of the resistor R103 is coupled to a second terminal of the first diode D103, and a second terminal of the resistor R103 is coupled to a power input terminal of the first power supplying unit 150. A first terminal of the Zenar diode ZD102 is coupled to the power output terminal of the motherboard 210, and a second terminal of the Zenar diode ZD102 is coupled to a ground. The capacitor C100 is connected with the Zenar diode ZD102 in parallel. The power switch circuit 240 includes a second diode D101 and a third diode D102. A first terminal of the second diode D101 is coupled to the LCD power circuit 110. A first terminal of the third diode D102 is coupled to a second terminal of the second diode D101, and a second terminal of the third diode D102 is coupled to the power input terminal of the first power supplying unit 150. The Zenar diode ZD102 and the capacitor C100 are used to filter out the noise from the motherboard output power VOM generated by the motherboard 210.

Detailed description of the motherboard switch circuit 230 and the power switch circuit 240 of FIG. 4 is described below.

When the display is under a normal display mode, the second diode D101 and the third diode D102 are conducted due to a forward bias voltage caused by the power VO1 provided by the LCD power circuit 110, such that the power switch circuit 240 is turned on. At this time, because the display is under a normal display mode, the motherboard 210 may generate a larger current, such that a voltage drop is generated in the resistor R103 when the motherboard output power VOM is transmitted via the first diode D103 and the resistor R103, wherein the voltage drop in the resistor R103 is larger than a voltage drop generated by a single diode. Due to a voltage drop of a single diode being fixed, the voltage VO1 may be affected. In other words, two fixed diode voltage drops provided by the second diode D101 and the third diode D102 may affect the voltage VO1. Meanwhile, except for a single fixed diode voltage drop provided by the first diode D103, the power VOS is also affected by the voltage drop of the resistor R103 being larger than the single fixed diode voltage drop, wherein the voltage drop of the resistor R103 is generated by a larger current from the motherboard 210. Therefore, the first diode D103 is in a reverse bias state, such that the motherboard output power VOM provided by the motherboard 210 is isolated from the power input terminal of the first power supplying unit 150. In sum, the power VOS received by the first power supplying unit 150 is provided only by the power VO1 provided by the LCD power circuit 110.

When the display is under a sleep display mode, the motherboard 210 may generate a smaller current; thereby the voltage drop generated in the resistor R103 is smaller than the single fixed diode voltage drop. Thus, a voltage drop of the motherboard output power VOM only includes the single fixed diode voltage drop of the first diode D103 and the voltage drop of the resistor R103, wherein the voltage drop of the resistor R103 is smaller than the single fixed diode voltage drop. Due to a voltage drop of the voltage VO1 being equal to a fixed voltage drop caused by the two diodes D101 and D102, the second diode D101 and the third diode D102 are in a reverse bias state and the first diode D103 is in a forward bias state, such that the power switch circuit 240 is turned off and the motherboard switch circuit 230 is turned on. Thus, in a sleep display mode, the power VOS received by the first power supplying unit 150 is generated according to the motherboard output power VOM provided by the motherboard 210.

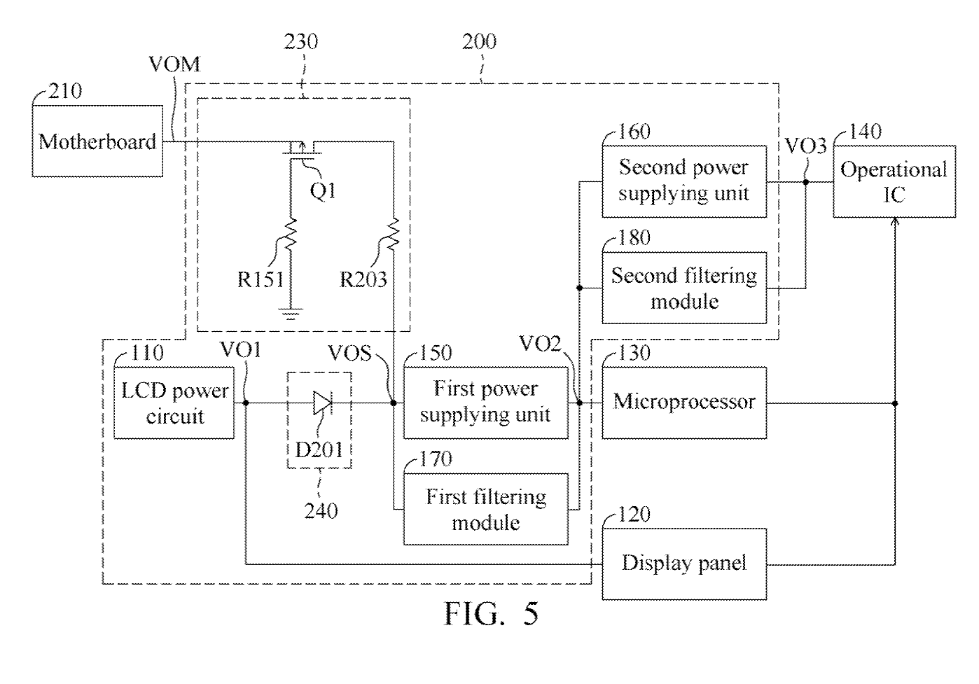

Referring to FIG. 5, FIG. 5 shows a schematic illustrating the LCD power supplying circuit 200 of FIG. 2 according to a fourth embodiment of the disclosure, wherein FIG. 5 mainly shows the power switch circuit 240 and the motherboard switch circuit 230 of FIG. 2. As shown in FIG. 5, the motherboard switch circuit 230 includes a n type metal-oxide-semiconductor (NMOS) transistor Q1, a first resistor 8203 and a second resistor R151. The power switch circuit 240 includes a diode D201. A source and a base of the NMOS transistor Q1 are coupled to the power output terminal of the motherboard 210 for receiving the motherboard output power VOM. A first terminal of the first resistor R203 is coupled to a drain of the NMOS transistor Q1, and a second terminal of the first resistor R203 is coupled to the power input terminal of the first power supplying unit 150. A first terminal of the second resistor R151 is coupled to a gate of the NMOS transistor Q1, and a second terminal of the second resistor R151 is coupled to the ground. A first terminal of the diode D201 is coupled to the LCD power circuit 110, and a second terminal of the diode D201 is coupled to the power input terminal of the first power supplying unit 150. The second resistor R151 is used to adjust a bias current of the NMOS transistor Q1.

Detailed description of the motherboard switch circuit 230 and the power switch circuit 240 of FIG. 5 is described below.

When the display enters a normal display mode, the motherboard 210 may generate a larger current, such that the motherboard output power VOM is affected by a voltage drop of the first resistor 8203 that is larger than a single fixed diode voltage drop (assume that a voltage drop of the NMOS transistor Q1 is ignored), and the power VO1 provided by the LCD power circuit 110 is affected by a single fixed diode voltage drop of the diode D201. Thus, if occurring, the diode D201 is in a forward bias state, and the NMOS transistor Q1 is turned off by a reverse bias state. At this time, the power VOS received by the first power supplying unit 150 is generated according to the power VO1 generated by the LCD power circuit 110 rather than the motherboard output power VOM provided by the motherboard 210.

When the display enters a sleep display mode, the motherboard 210 may generate a smaller current, such that the motherboard output power VOM is affected by a voltage drop of the first resistor 8203 that is smaller than the single fixed diode voltage drop, and the power VO1 provided by the LCD power circuit 110 is affected by a single fixed diode voltage drop of the diode D201. Therefore, if occurring, the diode D201 is in a reverse bias state, and the NMOS transistor Q1 is turned on by a forward bias state. At this time, the power VOS received by the first power supplying unit 150 is generated according to the motherboard output power VOM provided by the motherboard 210 rather than the power VO1 generated by the LCD power circuit 110.

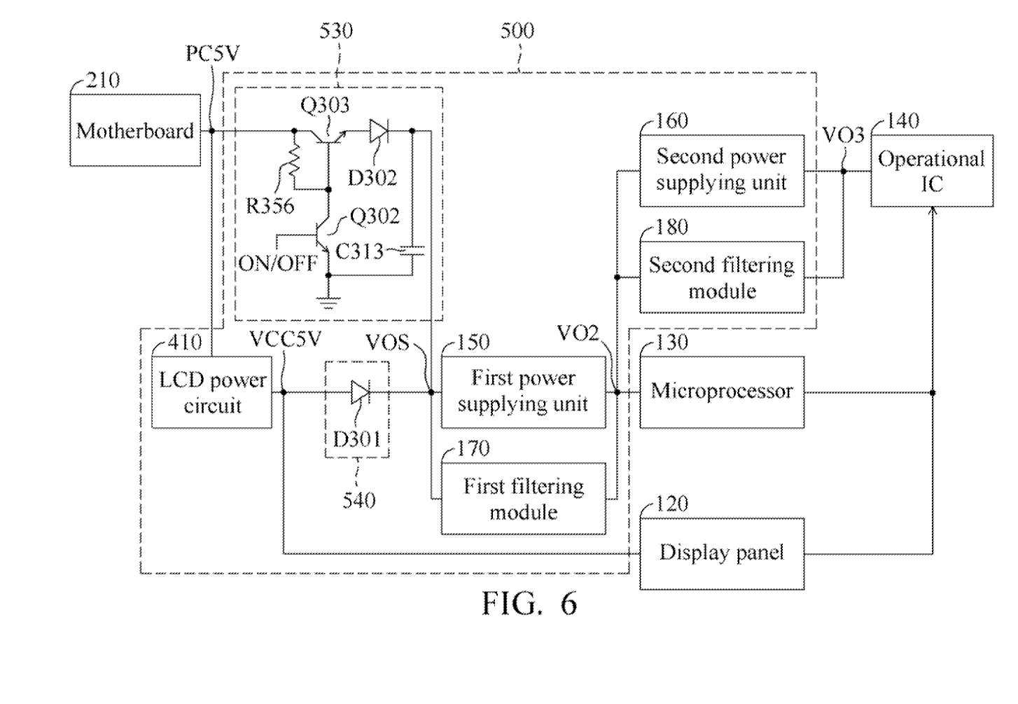

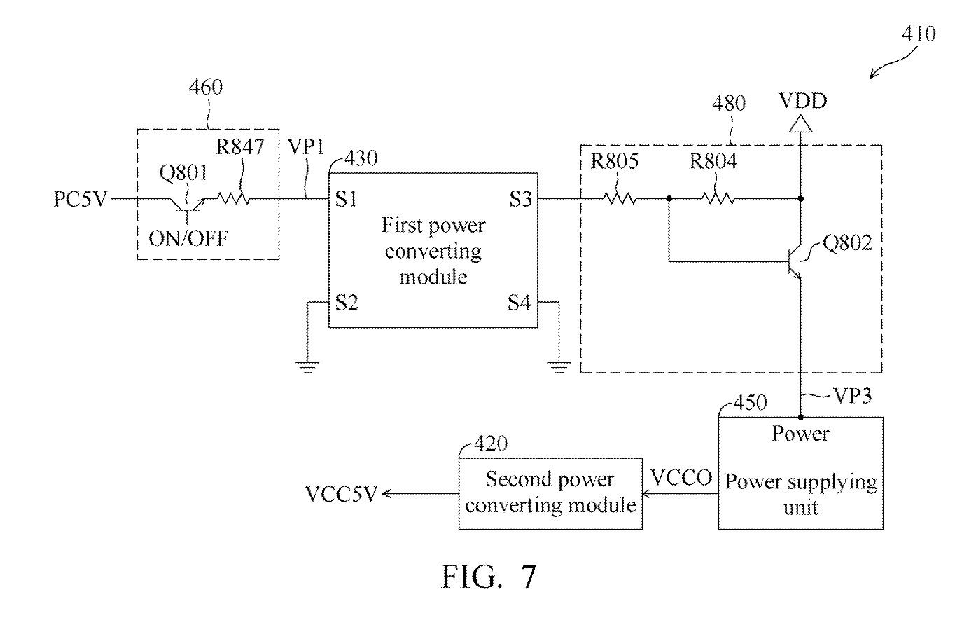

The embodiments of the disclosure further disclose a control signal which is used to switch a normal display mode and a sleep display mode for a display, and to switch power supply from an LCD power circuit or a motherboard for an LCD power supplying circuit, wherein the LCD power supplying circuit includes the LCD power circuit which needs the control signal for operation, so as to switch power supply from the LCD circuit or the motherboard. Referring to FIG. 6 and FIG. 7, FIG. 6 and FIG. 7 show an LCD power supplying circuit 500 according to a fifth embodiment of the disclosure. FIG. 6 shows a schematic illustrating a power switch circuit 540 and a motherboard switch circuit 530 disclosed in the fifth embodiment, and FIG. 7 shows a schematic illustrating an LCD power circuit 410 disclosed in the fifth embodiment. In addition, the LCD power supplying circuit 500 of FIG. 6 and the LCD power circuit 410 of FIG. 7 both need a control signal ON/OFF to control a trigger mechanism for switching power, wherein the control signal ON/OFF is at a high voltage level under a normal display mode and the control signal ON/OFF is at a low voltage level under a sleep display mode for the display.

As shown in FIG. 6, the LCD power supplying circuit 500 includes the first power supplying unit 150, the second power supplying unit 160, the first filtering module 170 corresponding to the first power supplying unit 150 and the second filtering module 180 corresponding to the second power supplying unit 160. The LCD power supplying circuit 500 further includes the motherboard switch circuit 530, the power switch circuit 540 and the LCD power circuit 410. The motherboard switch circuit 530 includes a first npn type bipolar junction transistor (BJT) Q303, a second npn type BJT Q302, a first diode D302, a capacitor C313 and a resistor R356. The power switch circuit 540 includes a second diode D301. A collector of the first npn type BJT Q303 is coupled to the power output terminal of the motherboard 210 for receiving the motherboard output power VOM, and a base of the first npn type BJT Q303 is coupled to a control signal ON/OFF, which is used to change a conduction state of the first npn type BJT Q303 in response to the control signal ON/OFF (i.e. a sleep display mode and a normal display mode). A collector of the second npn type BJT Q302 is coupled to the base of the first npn type BJT Q303, and an emitter of the second npn type BJT Q302 is coupled to the ground. A first terminal of the first diode D302 is coupled to an emitter of the first npn type BJT Q303, and a second terminal of the first diode D302 is coupled to the power input terminal of the first power supplying unit 150. A first terminal of the resistor R356 is coupled to the collector of the first npn type BJT Q303, and a second terminal of the resistor R356 is coupled to the base of the first npn type BJT Q303. A first terminal of the capacitor C313 is coupled to the second terminal of the first diode D302, and a second terminal of the capacitor C313 is coupled to the emitter of the second npn type BJT Q302. A first terminal of the second diode D301 is coupled to the LCD power circuit 110 for receiving the power VO1, and a second terminal of the second diode D301 is coupled to the first power supplying unit 150.

As shown in FIG. 7, the LCD power circuit 410 includes a first switch module 460, a first power converting module 430, a second switch module 480, a power supplying unit 450 and a second power converting module 420. An input terminal of the first switch module 460 is coupled to the power output terminal of the motherboard 210, i.e. a power PC5V of FIG. 6, so as to receive the power PC5V provided by the motherboard 210. The first switch module 460 is used to determine whether to generate a power VP1 according to the power PC5V in response to the control signal ON/OFF, i.e. it is determined whether to generate the power VP1 according to the display being under a sleep display mode or a normal display mode. In other words, the first switch module 460 is a switch for determining whether to provide the power VP1. An input terminal of the first power converting module 430 is coupled to an output terminal of the first switch module 460. When the first power converting module 430 receives the power VP1 with a high voltage level and a positive voltage difference between an input terminal S1 and an input terminal S2 coupled to the ground is generated, an output terminal S3 and an output terminal S4 coupled to the ground of the first power converting module 430 are conducted. An input terminal of the second switch module 480 is coupled to the output terminal S3 of the first power converting module 430, and the second switch module 480 is further coupled to a direct current (DC) power VDD externally. The second switch module 480 generates a power VP3 according to the DC power VDD in response to whether the output terminals S3 and S4 of the first power converting module 430 are conducted. In other words, the second switch module 480 is a switch for determining whether to provide the power VP3. In one embodiment of the disclosure, a transistor may be disposed between the output terminals S3 and S4 of the first power converting module 430, which is turned on or off according to whether a voltage difference between the input terminals S1 and S2 of the first power converting module 430 exists, so as to generate a conductive current between the output terminals S3 and S4 of the first power converting module 430. A switch control terminal Power of the power supplying unit 450 is coupled to an output terminal of the second switch module 480. The power supplying unit 450 provides a power VCCO when the power VP3 received by the switch control terminal Power is at a high voltage level. On the contrary, the power supplying unit 450 does not provide the power VCCO when the power VP3 received by the switch control terminal Power is at a low voltage level. An input terminal of the second power converting module 420 is coupled to an output terminal of the power supplying unit 450, and an output terminal of the second power converting module 420 is coupled to the output terminal of the LCD power circuit 410 shown in FIG. 6. The second power converting module 420 converts the power VCCO into the power VCC5V and outputs the power VCC5V in the output terminal of the LCD power circuit 410, and then provides the power VCC5V to the power switch circuit 540.

The first switch module 460 includes a pnp type BJT Q801 and a resistor R847. An emitter of the pnp type BJT Q801 is coupled to the power output terminal of the motherboard 210 for receiving the power PC5V, and a base of the pnp type BJT Q801 is coupled to the control signal ON/OFF. A first terminal of the resistor R847 is coupled to a collector of the pnp type BJT Q801, and a second terminal of the resistor R847 is coupled to the input terminal S1 of the first power converting module 430. The second switch module 480 includes a npn type BJT Q802 and two resistors R804 and R805. A collector of the npn type BJT Q802 is coupled to the DC power VDD, and an emitter of the npn type BJT Q802 is coupled to the switch control terminal Power of the power supplying unit 450. A first terminal of the resistor R805 is coupled to the output terminal S3 of the first power converting module 430, and a second terminal of the resistor R805 is coupled to a base of the npn type BJT Q802. A first terminal of the resistor R804 is coupled to the second terminal of the resistor R805, and a second terminal of the resistor R804 is coupled to the collector of the npn type BJT Q802.

Detailed description of the motherboard switch circuit 530 and the power switch circuit 540 of FIG. 6 and LCD power circuit 410 of FIG. 7 is described below. When the display enters a normal display mode, the control signal ON/OFF is at a high voltage level, such that the second npn type BJT Q302 is turned on, and the first npn type BJT Q303 is turned off due to the base voltage of the first npn type BJT Q303 being pulled down by a conductive current of the second npn type BJT Q302. Thus, a residual voltage of the power PC5V transmitted to the input terminal of the first power supplying unit 150 is lower than a residual voltage of the power VCC5V transmitted to the input terminal of the first power supplying unit 150, such that the power VOS generates a reverse bias in response to the first diode D302. Thus, the power PC5V provided by the motherboard 210 is isolated from the first power supplying unit 150, and the power VOS is generated by the power VCC5V provided by the LCD power circuit 410 via the second diode D301 and then the power VOS is provided to the first power supplying unit 150. Simultaneously, in the LCD power circuit 410, the pnp type BJT Q801 is turned off because the control signal ON/OFF is at a high voltage level, and then the power VP1 of FIG. 7 can not be generated. The output terminals S3 and S4 of the first power converting module 430 may not be conducted to generate the conductive current as no power VP1 is received by the first power converting module 430. Thus, the base voltage of the npn type BJT Q802 may not be pulled down according to the current between the output terminals S3 and S4 of the first power converting module 430, such that the npn type BJT Q802 is turned on and the power VP3 is at a high voltage level. After receiving the power VP3 with a high voltage level, the power supplying unit 450 provides the power VCCO to the second power converting module 420 to generate the power VCC5V, and then the power VCC5V is provided to the power switch circuit 540 of FIG. 6.

When the display enters a sleep display mode, the control signal ON/OFF is at a low voltage level, such that the second npn type BJT Q302 is turned off, and the first npn type BJT Q303 is turned on as the base voltage is not pulled down. Thus, the residual voltage of the power PC5V transmitted to the input terminal of the first power supplying unit 150 is higher than the residual voltage of the power VCC5V transmitted to the input terminal of the first power supplying unit 150, such that the power VOS generates a reverse bias in response to the second diode D301 to isolate the power VCC5V provided by the LCD power circuit 410 from the first power supplying unit 150, and the power VOS is generated according to the power PC5V provided by the motherboard 210 and then the power VOS is provided to the first power supplying unit 150. In the LCD power circuit 410, the pnp type BJT Q801 is turned on by the control signal ON/OFF with a low voltage level, such that the first switch module 460 generates the power VP1 with a high voltage level in the input terminal S1 of the first power converting module 430. The first power converting module 430 conducts the output terminals S3 and S4 of the first power converting module 430 according to the power VP1 with a high voltage level. In the second switch module 480, the base of the npn type BJT Q802 is pulled down due to the conductive current between the output terminals S3 and S4 of the first power converting module 430; thereby the npn type BJT Q802 is turned off. Thus, the power VP3 output by the npn type BJT Q802 is at a low voltage level. After the switch control terminal Power of the power supplying unit 450 receives the power VP3 with a low voltage level, the power supplying unit 450 stops providing the power VCCO. Therefore, the second power converting module 420 can not generate the power VCC5C according to the power VCCO, such that the LCD power circuit 410 of FIG. 6 also can not provide the power VCC5C to the power switch circuit 540.

By the control signal ON/OFF of FIG. 6 and FIG. 7 which actively controls the power supplying manner according to a normal display mode and a sleep display mode, in addition to the embodiments that isolate the power to be isolated from power supply paths with reverse bias manner, the power VCC5V provided by the LCD power circuit 410 is closed to further ensure power consumption of the LCD power supplying circuit 500 under a sleep display mode.

The LCD power supplying circuit disclosed in the embodiments of the disclosure may isolate a power provided by an LCD power circuit under a sleep display mode of a display, and may use a power provided by a motherboard as a power supply for the display under a sleep display mode. Thus, the power consumption of the power provided by the LCD power circuit, which would normally occur under a sleep mode, may be provided by the motherboard, so that unnecessary power consumption is prevented under a sleep display mode for the display.

It is to be understood that even though numerous characteristics and advantages of the present embodiments have been set forth in the foregoing description, together with details of the structures and functions of the embodiments, the disclosure is illustrative only; and that changes may be made in detail, especially in matters of shape, size, and arrangement of parts, within the principles of the embodiments, to the full extent indicated by the broad general meaning of the terms in which the appended claims are expressed.

1. A liquid crystal display (LCD) power supplying circuit, comprising:
a motherboard switch circuit, having an input terminal coupled to a power output terminal of a motherboard;
an LCD power circuit;
a power switch circuit, having an input terminal coupled to the LCD power circuit; and
a first power supplying unit coupled to an output terminal of the motherboard switch circuit, an output terminal of the power switch circuit and a microprocessor, and supplying power from the motherboard or power from the LCD power circuit to the microprocessor.

2. The LCD power supplying circuit as claimed in claim 1, wherein the motherboard switch circuit is turned off and the power switch circuit is turned on when a display enters a normal display mode, such that the power from the LCD power circuit is supplied to the first power supplying unit via the power switch circuit.

3. The LCD power supplying circuit as claimed in claim 1, wherein the motherboard switch circuit is turned on and the power switch circuit is turned off when a display enters a sleep display mode, such that the power from the motherboard is supplied to the first power supplying unit via the motherboard switch circuit.

4. The LCD power supplying circuit as claimed in claim 1, wherein the motherboard switch circuit comprises:
a first diode, having a first terminal coupled to the power output terminal of the motherboard; and
a resistor, having a first terminal coupled to a second terminal of the first diode and a second terminal coupled to the first power supplying unit.

5. The LCD power supplying circuit as claimed in claim 4, wherein the motherboard switch circuit further comprises:
a Zenar diode, having a first terminal coupled to the power output terminal of the motherboard and a second terminal coupled to a ground; and
a first capacitor connected with the Zenar diode in parallel.

6. The LCD power supplying circuit as claimed in claim 4, wherein the power switch circuit comprises:
a second diode, having a first terminal coupled to the LCD power circuit; and
a third diode, having a first terminal coupled to a second terminal of the second diode and a second terminal coupled to the first power supplying unit.

7. The LCD power supplying circuit as claimed in claim 1, wherein the motherboard switch circuit comprises:
an NMOS transistor, having a source and a base both coupled to the power output terminal of the motherboard; and
a first resistor, having a first terminal coupled to a drain of the NMOS transistor and a second terminal coupled to the first power supplying unit.

8. The LCD power supplying circuit as claimed in claim 7, wherein the motherboard switch circuit further comprises:
a second resistor, having a first terminal coupled to a gate of the NMOS transistor and a second terminal coupled to a ground.

9. The LCD power supplying circuit as claimed in claim 7, wherein the power switch circuit comprises:
a fourth diode, having a first terminal coupled to the LCD power circuit and a second terminal coupled to the first power supplying unit.

10. The LCD power supplying circuit as claimed in claim 1, wherein the motherboard switch circuit comprises:
a first npn type bipolar junction transistor (BJT), having a collector coupled to the power output terminal of the motherboard and a base coupled to a control signal;
a second npn type BJT, having a collector coupled to the base of the first npn type BJT and an emitter coupled to a ground; and
a fifth diode, having a first terminal coupled to an emitter of the first npn type BJT and a second terminal coupled to the first power supplying unit,
wherein the control signal is at a low voltage level when a display comprising the LCD power circuit supplying circuit enters a sleep display mode.

11. The LCD power supplying circuit as claimed in claim 10, wherein the motherboard switch circuit further comprises:
a resistor, having a first terminal coupled to the collector of the first npn type BJT and a second terminal coupled to the base of the first npn type BJT; and
a capacitor, having a first terminal coupled to the second terminal of the fifth diode and a second terminal coupled to the emitter of the second npn type BJT.

12. The LCD power supplying circuit as claimed in claim 10, wherein the power switch circuit comprises:
a sixth diode, having a first terminal coupled to the LCD power circuit and a second terminal coupled to the first power supplying unit.

13. The LCD power supplying circuit as claimed in claim 10, wherein the LCD power circuit comprises:
a first switch module, having an input terminal coupled to the power output terminal of the motherboard, wherein the first switch module determines whether to generate a second power according to a first power generated by the motherboard in response to the control signal;
a first power converting module, having an input terminal coupled to an output terminal of the first switch module, a first output terminal and a second output terminal, wherein the first power converting module generates a current between the first and second output terminals according to whether the second power is at a high voltage level;
a second switch module, having an input terminal coupled to the first output terminal of the first power converting module, wherein the second switch module generates a third power according to whether the current between the first and second output terminals of the first power converting module is generated;
a second power supplying unit, having a switch control terminal coupled to an output terminal of the second switch module, wherein the second power supplying unit generates a fourth power according to whether the third power is at a high voltage level; and
a second power converting module, having an input terminal coupled to an output terminal of the second power supplying unit and an output terminal coupled to the output terminal of the power switch circuit, wherein the second power converting module converts the fourth power into a fifth power and outputs the fifth power to the output terminal of the power switch circuit.

14. The LCD power supplying circuit as claimed in claim 13, wherein the first switch module comprises:
a pnp type BJT, having an emitter coupled to the power output terminal of the motherboard and a base coupoled to the control signal; and
a first resistor, having a first terminal coupled to a collector of the pnp type BJT and a second terminal coupled to the first power converting module.

15. The LCD power supplying circuit as claimed in claim 13, wherein the second switch module comprises:
a third npn type BJT, having a collector coupled to a direct current (DC) power and an emitter coupled to the switch control terminal of the second power supplying unit;
a second resistor, having a first terminal coupled to the first output terminal of the first power converting module and a second terminal coupled to a base of the third npn type BJT; and
a third resistor, having a first terminal coupled to the second terminal of the second resistor and a second terminal coupled to the collector of the third npn type BJT.

16. The LCD power supplying circuit as claimed in claim 1, further comprising:
a first filtering module, filtering out noise from a power received by the first power supplying unit.

17. The LCD power supplying circuit as claimed in claim 1, wherein a display panel is coupled to the LCD power circuit, and the microprocessor is coupled to the first power supplying unit to receive a first output power provided by the first power supplying unit.

18. The LCD power supplying circuit as claimed in claim 17, further comprising:
a second power supplying unit, converting the first output power into a second output power and providing the second output power to an operational integrated circuit of a display; and
a second filtering module, filtering out noise from the second output power of the second power supplying unit.
